(19) United States
(12) Patent Application Publication
(10) Pub. No.: US 2026/0225020 A1
(43) Pub. Date: Aug. 6, 2026

(54) INTEGRATED SYNERGISTIC PURIFICATION PROCESS FOR SULFUR, DUST, AND NITROGEN OXIDES, USING CERAMIC FIBER TUBE

(71) Applicant: SHANDONG JINGYAO GLASS GROUP CO., LTD., Linyi (CN)

(72) Inventors: Yong Tang, Linyi (CN); Wencai Bo, Linyi (CN); Cundong Gao, Linyi (CN)

(21) Appl. No.: 19/464,740

(22) Filed: Jan. 30, 2026

(30) Foreign Application Priority Data
Feb. 5, 2025 (CN) 202510127920.8

(51) Int. Cl. B01D 46/24; B01D 39/20; B01D 41/04; B01D 46/10; B01D 46/26; B01D 46/681

(52) U.S. Cl. CPC B01D 46/2411; B01D 39/2082; B01D 41/04; B01D 46/103; B01D 46/26; B01D 46/681; B01D 2257/30; B01D 2257/404

(57) ABSTRACT

The present invention relates to the technical field of industrial waste gas purification, and more particularly, to an integrated synergistic process for integrated synergistic purification of sulfur, dust, and nitrogen oxides, using ceramic fiber tube, adopting a synergistic purification device includes a treatment tank, wherein a dust separation plate is horizontally disposed inside the treatment tank, a plurality of rows of insertion holes are formed through the top of the dust separation plate with a plurality of insertion holes in each row, and ceramic fiber tubes are inserted into the insertion holes. After the ceramic fiber tubes in the present invention filter the waste gas for a certain period of time, as the drive shaft rotates in the reverse direction, the arc-shaped movable plate can cooperate with the arc-shaped surrounding plate to completely enclose the ceramic fiber tubes.

### CROSS-REFERENCE TO RELATED APPLICATIONS

This application claims priority benefits to Chinese Patent Application No. 202510127920.8, filed February 05, 2025, the contents of which are incorporated herein by reference.

### FIELD OF TECHNOLOGY

The present invention relates to the technical field of waste gas treatment, and more particularly, to an integrated synergistic purification process for sulfur, dust, and nitrogen oxides, using ceramic fiber tube.

### BACKGROUND OF THE INVENTION

The integrated synergistic purification process for sulfur, dust, and nitrogen oxides, using ceramic fiber tube is a denitrification and dust removal equipment widely used in industries such as glass manufacturing, waste incineration, coking, and chemical engineering. When performing a treatment to the waste gas using the denitrification and dust removal equipment, gas containing dust, sulfur, and nitrate is injected with limestone powder at the front flue, and initially mixed through a static mixer, and then enters a flue gas fluidized mixing tower where a primary desulfurization reaction is carried out; thereafter, the gas passes through the flue behind the tower, and diluted ammonia gas is injected through an ammonia injection grid, and uniformly distributed by a flow guide plate, and then the gas enters a ceramic fiber filter cartridge; larger-sized dust settles under the action of gravity, smaller-sized dust deposits on the surface of the ceramic fiber filter cartridge, and a second desulfurization reaction is performed on the dust cake layer formed on the surface of the ceramic fiber filter cartridge; the gas without dust and sulfur passes through the surface of the ceramic fiber filter cartridge and then contacts the catalyst layer on the inner wall of the ceramic fiber filter cartridge to undergo a reaction, such that, the nitrogen oxides are primarily removed, and then the gas is discharged by an induced draft fan; when the dust deposited on the surface of the ceramic fiber filter cartridge reaches a certain value, compressed air is used to perform a pulse ash cleaning to the filter cartridge.

However, during the pulse ash cleaning of the surface of the ceramic fiber filter cartridge, due to the lack of protective devices on the outer side of the existing ceramic fiber filter cartridge, the cleaned dust will spread to the surface of adjacent ceramic fiber filter cartridge during the pulse ash cleaning operation, thereby affecting the cleaning efficiency and cleaning effect of the ceramic fiber filter cartridge.

### SUMMARY OF THE INVENTION

To address the above-mentioned problem, the present invention provides an integrated synergistic purification process for sulfur, dust, and nitrogen oxides, using ceramic fiber tube to solve the problem proposed in the above background art.

To achieve the above objective, the present invention provides the following technical solution:

An integrated synergistic purification process for sulfur, dust, and nitrogen oxides, using ceramic fiber tube, adopting a synergistic purification device comprising a treatment tank; a dust separation plate is horizontally disposed inside the treatment tank; a plurality of rows of insertion holes are defined through a top of the dust separation plate, with a plurality of insertion holes in each row; a ceramic fiber tubes is inserted into the insertion holes; an air suction assembly is disposed at a top of the plurality of rows of ceramic fiber tubes; an arc-shaped surrounding plate coaxial with the ceramic fiber tubes is disposed on an outer periphery of the ceramic fiber tubes located below the dust separation plate; each of a top end and a bottom end of the arc-shaped surrounding plate is fixedly connected with a first fixing ring, and the first fixing ring located at the top is rotatably connected to the bottom of the dust separation plate; an arc-shaped movable plate is disposed in an inner side of the arc-shaped surrounding plate; and is coaxial with the arc-shaped surrounding plate each of a top end and a bottom end of the arc-shaped movable plate is fixedly connected with a second fixing ring; both of the two second fixing rings are rotatably mounted on an inner side of the arc-shaped surrounding plate; a fixing rod is fixedly connected to an inner side of the second fixing ring located at the bottom; a rotating shaft is vertically and fixedly connected to a center of a bottom of the fixing rod; a fixing plate is horizontally disposed at the bottom of the plurality of fixing rods with are located in the same row; opposite ends of the fixing plate are fixedly connected to the inner wall of the treatment tank; the plurality of rotating shafts located in the same row are vertically inserted through the fixing plate directly opposite to the bottom; a driving assembly for driving the rotating shafts to rotate is disposed at a bottom of the fixing plate; an one-way bushing is sleeved on the rotating shaft, and an idling direction of the one-way bushing is opposite to a forward rotation direction of the rotating shaft; a plurality of L-shaped connecting rods are fixedly connected between the one-way bushing and the first fixing ring at the bottom; an exhaust pipe is connected to the top of the treatment tank; an air inlet pipe is connected to a side wall of the treatment tank; an ash discharge pipe is connected to the bottom of the treatment tank; an induced draft fan is mounted on the ash discharge pipe.

Further, the air suction assembly comprises a plurality of air suction pipes; the plurality of air suction pipes are respectively distributed in one-to-one correspondence at the tops of the plurality of rows of ceramic fiber tubes; an air compressor is connected to the top of the air suction pipe located in the middle; the air compressor is connected to the exhaust pipe at the top of the treatment tank; the air suction pipe located in the middle position is individually connected to each of the other air suction pipes with a connecting pipe therebetween; a control valve is mounted on the connecting pipe; a plurality of insertion pipes are vertically connected to the bottom of the air suction pipe; the plurality of insertion pipes are respectively inserted in one-to-one correspondence at the top openings of the plurality of ceramic fiber tubes directly below the air suction pipe.

Further, the driving assembly comprises a driving shaft; the driving shaft is horizontally disposed at the bottom of the fixing plate, and an end of the drive shaft is drivingly connected with a driving motor; fixing blocks are rotatably sleeved on positions of the drive shaft adjacent to opposite ends, and the fixing blocks are fixedly connected to the bottom of the fixing plate; a plurality of first bevel gears are sleeved on the drive shaft , and the plurality of first bevel gears are respectively opposite to the plurality of rotating shafts on the fixing plate in a one-to-one correspondence; a second bevel gear is fixedly sleeved on the bottom end of the rotating shaft, and the second bevel gear engages with the adjacent first bevel gear.

Further, a cleaning rod is vertically and fixedly connected between the two second fixing rings; brush bristles are uniformly disposed on one side of the cleaning rod adjacent to the ceramic fiber tubes; the brush bristles are capable of contacting with the surface of the ceramic fiber tubes.

Further, an annular mounting groove is defined on an inner side of a top edge of the insertion hole; a supporting ring is slidably mounted in the mounting groove; a supporting spring is fixedly connected between a bottom of the supporting ring and an inner wall of a bottom of the mounting groove.

Further, an arc length of the arc-shaped movable plate is the same as that of the arc-shaped surrounding plate, and both the arc length of the arc-shaped movable plate and the arc length of the arc-shaped surrounding plate are greater than half of a perimeter of the circumference thereon.

Further, a diameter of the treatment tank adjacent to the bottom end gradually decreases from the top to the bottom, gradually, and the inner wall of the bottom end of the treatment tank is smooth.

Further, the top edge of the ceramic fiber tube protrudes outwardly, and a width of a protruding part matches a width of the supporting ring; the bottom end of the ceramic fiber tube is higher than the bottom of the arc-shaped movable plate.

Further, a gap is formed between the arc-shaped movable plate and the ceramic fiber tube; a gap also is formed between two adjacent arc-shaped surrounding plates.

Technical effects and advantages of the present invention:

1. The present invention is provided with the arc-shaped movable plate and the arc-shaped surrounding plate; after the ceramic fiber tubes filter the waste gas for a certain period of time, as the drive motor drives the drive shaft to rotate in the reverse direction, the arc-shaped movable plate can cooperate with the arc-shaped surrounding plate to completely enclose the ceramic fiber tube; at this time, as the air compressor performs a pulse ash cleaning to the ceramic fiber tube, the cleaned dust can be discharged through a bottom end of a circular tube enclosed by the arc-shaped surrounding plate and the arc-shaped movable plate and then discharged out of the treatment tank by the induced draft fan through the ash discharge pipe, thereby avoiding the defect that dust spreads to adjacent ceramic fiber tubes in the existing ash cleaning method, and improving a cleaning efficiency and a cleaning effect of the ceramic fiber tubes;

2. The present invention is provided with the air suction assembly; during the pulse ash cleaning of the ceramic fibers, the present invention can sequentially perform separate pulse ash cleaning operations on each row of ceramic fiber tubes; since the number of ceramic fiber tubes to be cleaned is small, the air compressor can apply a greater pulse pressure to the interior of the ceramic fiber tube, thereby ensuring the pulse ash cleaning effect on the ceramic fiber tubes;

3. The present invention is provided with the cleaning rod and the brush bristles; when the air compressor performs a pulse ash cleaning to the ceramic fiber tube, as the arc-shaped movable plate cooperates with the arc-shaped surrounding plate to enclose the ceramic fiber tubes, the cleaned dust can be discharged through the bottom end of a circular tube enclosed by the arc-shaped movable plate and the arc-shaped surrounding plate; after the dust is discharged for a certain period of time, as the drive motor drives the rotating shaft to rotate through the drive shaft, the arc-shaped movable plate can drive the cleaning rod to move along the outer periphery of the ceramic fiber tubes through the two second fixing rings; during the movement of the cleaning rod, the brush bristles on the cleaning rod can contact, clean and scrub the surface of the ceramic fiber tubes, thereby brushing off the dust remaining on the surface of the ceramic fiber tubes, and improving the ash cleaning effect on the ceramic fiber tubes.

### BRIEF DESCRIPTION OF THE DRAWINGS

FIG. 1 is a schematic diagram of the overall structure of the present invention;

FIG. 2 is a cross-sectional view of the overall structure of the present invention;

FIG. 3 is a three-dimensional schematic diagram of structures such as the ceramic fiber tube, the arc-shaped surrounding plate, the cleaning rod, and the driving assembly in the present invention;

FIG. 4 is a three-dimensional schematic diagram of the air suction assembly in the present invention;

FIG. 5 is a three-dimensional schematic diagram of structures such as the arc-shaped surrounding plate, the arc-shaped movable plate, the cleaning rod, and the rotating shaft in the present invention;

FIG. 6 is a three-dimensional schematic diagram of the arc-shaped surrounding plate, the arc-shaped movable plate, the cleaning rod, the fixing plate, the first fixing ring, and the second fixing ring in the present invention;

FIG. 7 is a three-dimensional schematic diagram of the first fixing ring, the connecting rod, the one-way bushing, the rotating shaft, and the second bevel gear in the present invention;

FIG. 8 is a three-dimensional schematic diagram of the dust separation plate, the supporting ring, and the supporting spring in the present invention.

In the figures: 1: treatment tank; 2: dust separation plate; 3: ceramic fiber tube; 4: air suction assembly; 41: air suction pipe; 42: air compressor; 43: connecting pipe; 44: control valve; 45: insertion pipe; 5: arc-shaped surrounding plate; 6: first fixing ring; 7: arc-shaped movable plate; 8: second fixing ring; 9: fixing rod; 10: rotating shaft; 11: fixing plate; 12: driving assembly; 121: drive shaft; 122: drive motor; 123: first bevel gear; 124: second bevel gear; 13: one-way bushing; 14: connecting rod; 15: exhaust pipe; 16: air inlet pipe; 17: ash discharge pipe; 18: induced draft fan; 19: cleaning rod; 20: brush bristles; 21: supporting ring; 22: supporting spring.

### DETAILED DESCRIPTION OF THE PREFERRED EMBODIMENTS

To make the objectives, technical solutions, and advantages of the embodiments of the present invention clearer, the technical solutions of the present invention will be described clearly and completely below in conjunction with the embodiments.

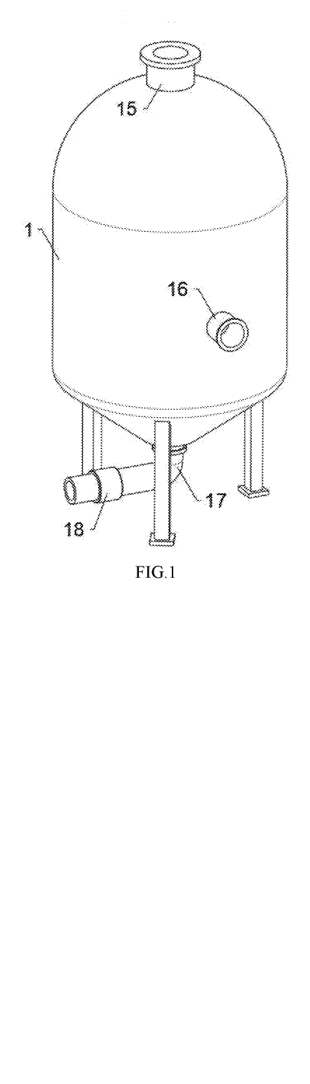

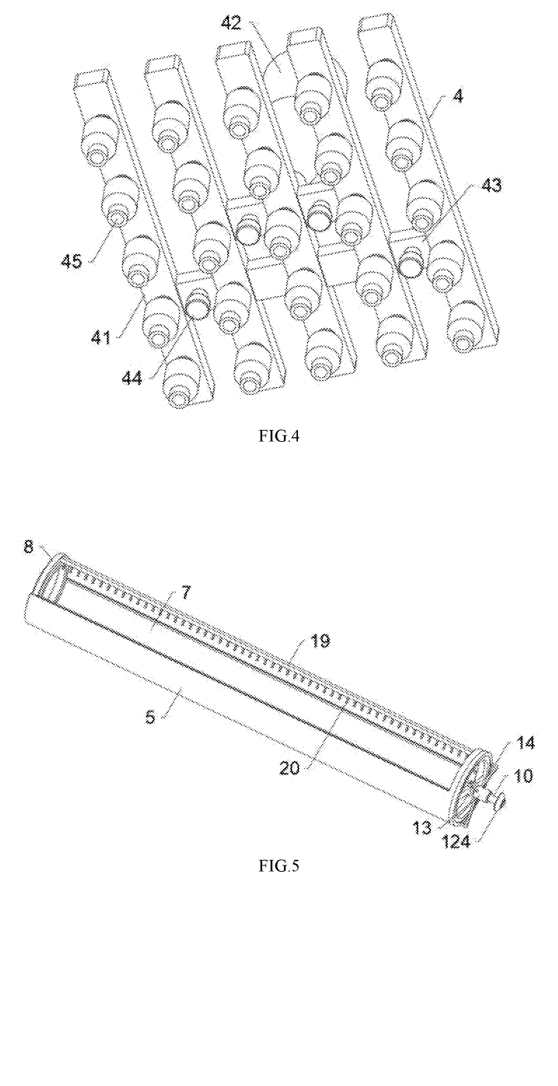

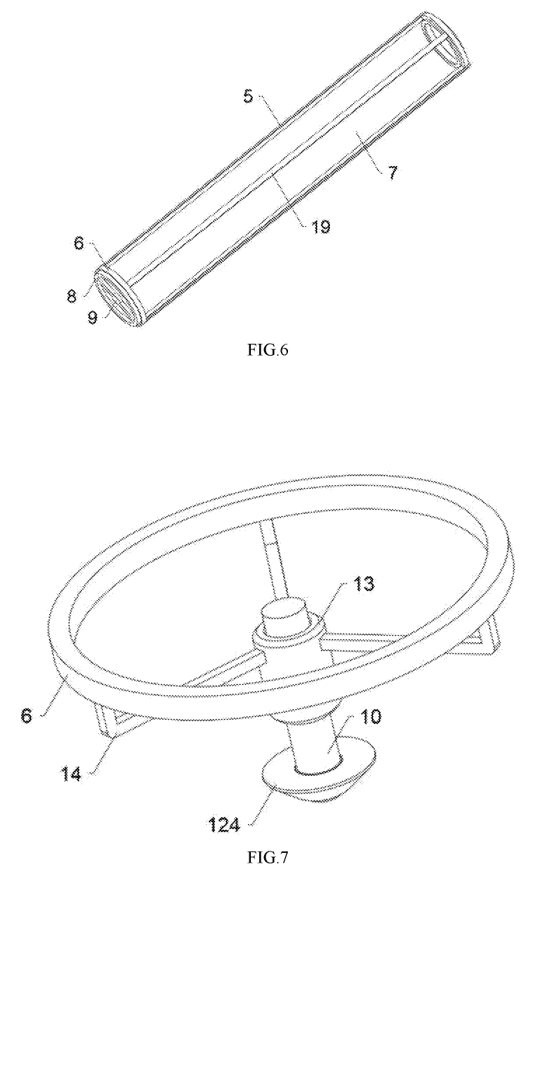

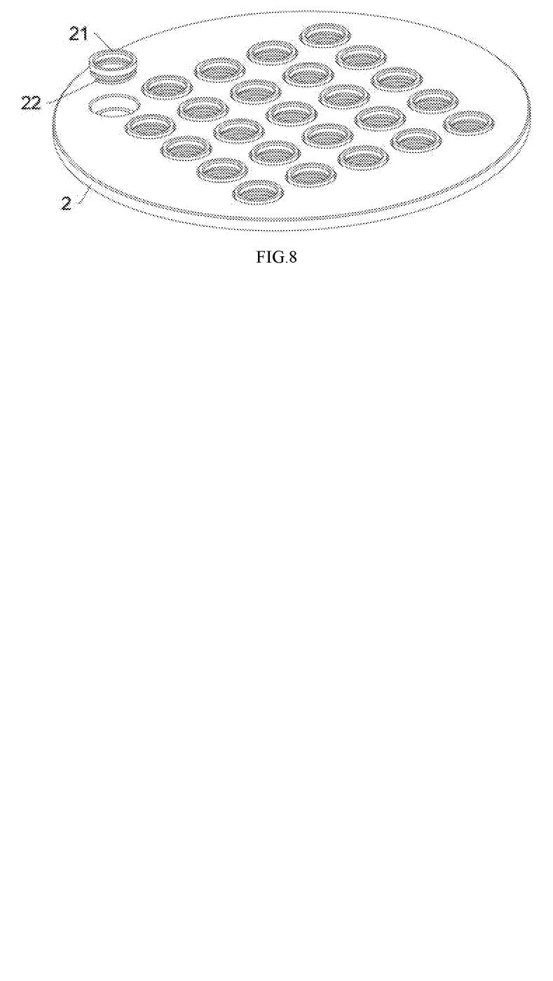

The present invention provides an integrated synergistic purification process for sulfur, dust, and nitrogen oxides using ceramic fiber tubes as shown in FIGS. 1 to 8, adopting a synergistic purification device comprising a treatment tank 1; a dust separation plate 2 is horizontally disposed inside the treatment tank 1; a plurality of rows of insertion holes are defined through a top of the dust separation plate 2, with a plurality of insertion holes in each row; a ceramic fiber tube 3 is inserted into the insertion hole; an air suction assembly 4 is disposed at a top of the plurality of rows of ceramic fiber tubes 3; an arc-shaped surrounding plate 5 coaxial with the ceramic fiber tube 3 is disposed on an outer periphery of the ceramic fiber tubes 3 located below the dust separation plate 2; each of a top end and a bottom end of the arc-shaped surrounding plate 5 is fixedly connected with a first fixing ring 6, and the first fixing ring 6 located at the top is rotatably connected to the bottom of the dust separation plate 2; an arc-shaped movable plate 7 is disposed in an inner side of the arc-shaped surrounding plate 5 and is coaxial with the arc-shaped surrounding plate 5 each of a top end and a bottom end of the arc-shaped movable plate 7 is fixedly connected with a second fixing ring 8; both of the two second fixing rings 8 are rotatably mounted on an inner side of the arc-shaped surrounding plate 5; a fixing rod 9 is fixedly connected to an inner side of the second fixing ring 8 located at the bottom; a rotating shaft 10 is vertically and fixedly connected to a center of a bottom of the fixing rod 9; a fixing plate 11 is horizontally disposed at the bottom of the plurality of fixing rods 9 with are located in the same row; opposite ends of the fixing plate 11 are fixedly connected to the inner wall of the treatment tank 1; the plurality of rotating shafts 10 located in the same row are vertically inserted through the fixing plate 11 directly opposite to the bottom; a driving assembly 12 for driving the rotating shafts 10 to rotate is disposed at a bottom of the fixing plate 11; an one-way bushing 13 is sleeved on the rotating shaft 10, and an idling direction of the one-way bushing 13 is opposite to a forward rotation direction of the rotating shaft 10; a plurality of L-shaped connecting rods 14 are fixedly connected between the one-way bushing 13 and the first fixing ring 6 at the bottom; an exhaust pipe 15 is connected to the top of the treatment tank 1; an air inlet pipe 16 is connected to a side wall of the treatment tank 1; an ash discharge pipe 17 is connected to the bottom of the treatment tank 1; an induced draft fan 18 is mounted on the ash discharge pipe 17; a diameter of the treatment tank 1 adjacent to the bottom end decreases from the top to the bottom, gradually, and the inner wall of the bottom end of the treatment tank 1 is smooth; an arc length of the arc-shaped movable plate 7 is the same as that of the arc-shaped surrounding plate 5, and both the arc length of the arc-shaped movable plate 7 and the arc length of the arc-shaped surrounding plate 5 are greater than half of a perimeter of the circumference thereon; the top edge of the ceramic fiber tube 3 protrudes outwardly, and a width of a protruding part matches a width of the supporting ring 21; the bottom end of the ceramic fiber tube 3 is higher than the bottom of the arc-shaped movable plate 7; a gap is formed between the arc-shaped movable plate 7 and the ceramic fiber tube 3; a gap also is formed between two adjacent arc-shaped surrounding plates 5;

The driving assembly 12 comprises a driving shaft 121; the driving shaft 121 is horizontally disposed at the bottom of the fixing plate 11, and an end of the drive shaft 121 is drivingly connected with a driving motor 122; fixing blocks are rotatably sleeved on positions of the drive shaft 121 adjacent to opposite ends, and the fixing blocks are fixedly connected to the bottom of the fixing plate 11; a plurality of first bevel gears 123 are sleeved on the drive shaft 121, and the plurality of first bevel gears 123 are respectively opposite to the plurality of rotating shafts 10 on the fixing plate 11 in a one-to-one correspondence; a second bevel gear 124 is fixedly sleeved on the bottom end of the rotating shaft 10, and the second bevel gear 124 engages with the adjacent first bevel gear 123;

During the process of the present invention treating waste gas, the arc-shaped surrounding plate 5 and the arc-shaped movable plate 7 can remain coincident; after the waste gas enters the interior of the treatment tank 1 through the air inlet pipe 16, with the operation of the air suction assembly 4, the waste gas can pass through the surface of the ceramic fiber tubes 3 and enter the interior of the ceramic fiber tubes 3 under the suction force of the air suction assembly 4, and then the filtered waste gas can be discharged out of the treatment tank 1 through the exhaust pipe 15 under the action of the air suction assembly 4; the dust in the waste gas can gradually deposit on the surface of the ceramic fiber tubes 3; during the process of the ceramic fiber tubes 3 filtering the waste gas, the drive motor 122 can be started intermittently; at this time, as the drive motor 122 drives the drive shaft 121 to rotate forward, the first bevel gears 123 on the drive shaft 121 can drive the rotating shafts 10 to rotate through the second bevel gears 124 on the rotating shafts 10; at this time, the one-way bushing 13 can drive the arc-shaped surrounding plate 5 to rotate together through the connecting rods 14, so that the arc-shaped surrounding plate 5 and the arc-shaped movable plate 7 can rotate around the ceramic fiber tubes 3 together, thereby ensuring that the waste gas entering the treatment tank 1 can uniformly contact the surface of the ceramic fiber tubes 3 and avoiding the situation that the waste gas treatment effect of the ceramic fiber tubes 3 is affected because one side of the ceramic fiber tubes 3 is shielded by the arc-shaped surrounding plate 5 or the arc-shaped movable plate 7;

After the ceramic fiber tubes 3 filter the waste gas for a certain period of time, as the drive motor 122 drives the drive shaft 121 to rotate reversely, the arc-shaped movable plate 7 can move together with the rotation of the rotating shaft 10, while the one-way bushing 13 at this time can keep idling, so that the arc-shaped surrounding plate 5 remains stationary; with the movement of the arc-shaped movable plate 7, when the arc-shaped movable plate 7 cooperates with the arc-shaped surrounding plate 5 to completely enclose the ceramic fiber tubes 3, the drive motor 122 stops; at this time, as the air compressor 42 presses compressed air into the interior of the ceramic fiber tubes 3 from the top ends of the ceramic fiber tubes 3, the dust adsorbed on the surface of the ceramic fiber tubes 3 can fall off from the surface of the ceramic fiber tubes 3; subsequently, the fallen dust can be discharged through the bottom end of the circular tube enclosed by the arc-shaped surrounding plate 5 and the arc-shaped movable plate 7 and then discharged out of the treatment tank 1 by the induced draft fan 18 through the ash discharge pipe 17, thereby avoiding the defect that dust spreads to adjacent ceramic fiber tubes 3 in the existing ash cleaning method and improving the cleaning efficiency and cleaning effect of the ceramic fiber tubes 3;

After the dust on the surface of the ceramic fiber tubes 3 is completely cleaned, the drive motor 122 can continue to drive the drive shaft 121 to rotate reversely, so that the arc-shaped movable plate 7 can gradually re-coincide with the arc-shaped surrounding plate 5; when the arc-shaped movable plate 7 is completely coincident with the arc-shaped surrounding plate 5, the drive motor 122 can first stop and then drive the drive shaft 121 to rotate forward, thereby repeating the above working process.

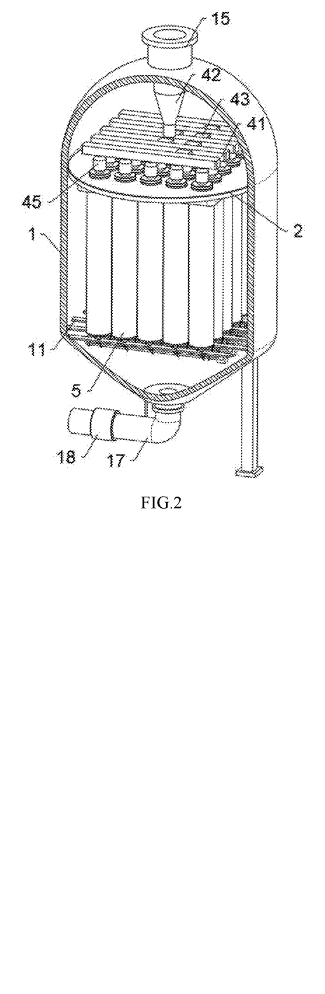

As shown in FIGS. 2 and 4, the air suction assembly 4 comprises a plurality of air suction pipes 41; the plurality of air suction pipes 41 are respectively distributed in one-to-one correspondence at the tops of the plurality of rows of ceramic fiber tubes 3; an air compressor 42 is connected to the top of the air suction pipe 41 located in the middle; the air compressor 42 is connected to the exhaust pipe 15 at the top of the treatment tank 1; the air suction pipe 41 located in the middle position is individually connected to each of the other air suction pipes 41 with a connecting pipe 43 therebetween; a control valve 44 is mounted on the connecting pipe 43; a plurality of insertion pipes 45 are vertically connected to the bottom of the air suction pipe 41; the plurality of insertion pipes 45 are respectively inserted in one-to-one correspondence at the top openings of the plurality of ceramic fiber tubes 3 directly below the air suction pipe 41;

By being provided with the air suction assembly 4, during the process of the ceramic fiber tubes 3 in the treatment tank 1 filtering the waste gas, the control valves 44 on all connecting pipes 43 can be kept in an open state, so that all ceramic fiber tubes 3 can suck the waste gas in the treatment tank 1 into the ceramic fiber tubes 3 for filtration treatment under the suction force of the insertion pipes 45 at their top ends, subsequently, the filtered waste gas can be discharged out of the treatment tank 1 through the exhaust pipe 15 under the action of the air compressor 4;

After the ceramic fiber tubes 3 have performed filtration for a certain period of time, in order to ensure the filtration effect of the ceramic fiber tubes 3, it is necessary to perform pulse ash cleaning on the ceramic fiber tubes 3; however, since a general treatment tank 1 is provided with a large number of ceramic fiber tubes 3 and the power of the air compressor 42 is fixed, the existing air compressor 42 has poor effect when performing pulse ash cleaning on the ceramic fiber tubes 3; at this time, by being provided with the air suction assembly 4, during the pulse ash cleaning operation on the ceramic fiber tubes 3, the present invention can sequentially perform separate pulse ash cleaning operations on each row of ceramic fiber tubes 3, and the specific ash cleaning operation is as follows:

When performing pulse ash cleaning on one of the rows of ceramic fiber tubes 3, first close all the control valves 44 on the connecting pipes 43 except for the row where the ceramic fiber tubes 3 to be cleaned are located; then make the drive motor 122 at the bottom of the row of ceramic fiber tubes 3 to be cleaned rotate reversely, thereby driving the arc-shaped movable plate 7 of the row to cooperate with the arc-shaped surrounding plate 5 of the row to enclose the plurality of ceramic fiber tubes 3 to be cleaned; subsequently, activate the air compressor 42 to suck external air, compress it, and then reversely pump the compressed air into the row of ceramic fiber tubes 3 to be cleaned, thereby completing the pulse ash cleaning operation on the row of ceramic fiber tubes 3; since the number of ceramic fiber tubes 3 to be cleaned is small, the air compressor 42 can apply greater pulse pressure to the interior of the ceramic fiber tubes 3, thereby ensuring the pulse ash cleaning effect on the ceramic fiber tubes 3.

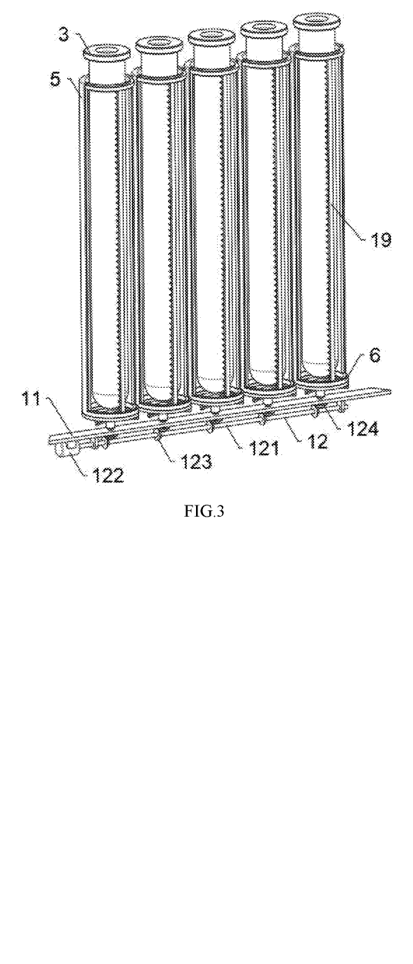

As shown in FIGS. 3 to 6, a cleaning rod 19 is vertically and fixedly connected between the two second fixing rings 8; brush bristles 20 are uniformly disposed on one side of the cleaning rod 19 close to the ceramic fiber tubes 3; the brush bristles 20 are capable of contacting the surface of the ceramic fiber tubes 3;

By being provided with the cleaning rod 19 and the brush bristles 20, when the air compressor 42 performs pulse ash cleaning on the ceramic fiber tubes 3, as the arc-shaped movable plate 7 cooperates with the arc-shaped surrounding plate 5 to enclose the ceramic fiber tubes 3, the cleaned dust can be discharged through the bottom end of the circular tube enclosed by the arc-shaped movable plate 7 and the arc-shaped surrounding plate 5; after the dust is discharged for a certain period of time, as the drive motor 122 drives the rotating shaft 10 to rotate through the drive shaft 121, the arc-shaped movable plate 7 can drive the cleaning rod 19 to move along the outer periphery of the ceramic fiber tubes 3 through the two second fixing rings 8; during the movement of the cleaning rod 19, the brush bristles 20 on the cleaning rod 19 can scrub against the surface of the ceramic fiber tubes 3, thereby brushing off the dust remaining on the surface of the ceramic fiber tubes 3 and improving the ash cleaning effect on the ceramic fiber tubes 3.

As shown in FIG. 8, an annular mounting groove is defined on an inner side of a top edge of the insertion hole; a supporting ring 21 is slidably mounted in the mounting groove; a supporting spring 22 is fixedly connected between a bottom of the supporting ring 21 and an inner wall of a bottom of the mounting groove;

By being provided with the supporting spring 22 and the supporting ring 21, when inserting the ceramic fiber tube 3 into the insertion hole on the dust separation plate 2, as the protruding part at the top end of the ceramic fiber tube 3 contacts the supporting ring 21 from top to bottom, the supporting ring 21 can gradually compress the supporting spring 22 under the action of pressure, so that the ceramic fiber tube 3 can move downward slowly and complete the installation operation, thereby avoiding damage to the ceramic fiber tube 3 due to collision with the insertion hole during the insertion of the ceramic fiber tube 3;

In addition, when the insertion pipe 45 is butted with the ceramic fiber tube 3, as the insertion pipe 45 is inserted into the ceramic fiber tube 3, the ceramic fiber tube 3 can be tightly connected with the insertion pipe 45 under the supporting force of the supporting spring 22 on the supporting ring 21, thereby ensuring the airtightness of the connection between the insertion pipe 45 and the ceramic fiber tube 3 and further improving the working efficiency of the air compressor 42.

The above embodiments are only used to illustrate the technical solution of the present invention, but not to limit it.

What is claimed is:

1. An integrated synergistic purification process for sulfur, dust, and nitrogen oxides, using ceramic fiber tube, adopting a synergistic purification device comprising a treatment tank, wherein a dust separation plate is horizontally disposed inside the treatment tank; a plurality of rows of insertion holes are defined through a top of the dust separation plate, with a plurality of insertion holes in each row; a ceramic fiber tube is inserted into the insertion hole; an air suction assembly is disposed at a top of the plurality of rows of ceramic fiber tubes; an arc-shaped surrounding plate coaxial with the ceramic fiber tube is disposed on an outer periphery of the ceramic fiber tubes located below the dust separation plate; each of a top end and a bottom end of the arc-shaped surrounding plate is fixedly connected with a first fixing ring, and the first fixing ring located at the top is rotatably connected to the bottom of the dust separation plate; an arc-shaped movable plate is disposed in an inner side of the arc-shaped surrounding plate and is coaxial with the arc-shaped surrounding plate each of a top end and a bottom end of the arc-shaped movable plate is fixedly connected with a second fixing ring; both of the two second fixing rings are rotatably mounted on an inner side of the arc-shaped surrounding plate; a fixing rod is fixedly connected to an inner side of the second fixing ring located at the bottom; a rotating shaft is vertically and fixedly connected to a center of a bottom of the fixing rod; a fixing plate is horizontally disposed at the bottom of the plurality of fixing rods with are located in the same row; opposite ends of the fixing plate are fixedly connected to the inner wall of the treatment tank; the plurality of rotating shafts located in the same row are vertically inserted through the fixing plate directly opposite to the bottom; a driving assembly for driving the rotating shafts to rotate is disposed at a bottom of the fixing plate; an one-way bushing is sleeved on the rotating shaft, and an idling direction of the one-way bushing is opposite to a forward rotation direction of the rotating shaft; a plurality of L-shaped connecting rods are fixedly connected between the one-way bushing and the first fixing ring at the bottom; an exhaust pipe is connected to the top of the treatment tank; an air inlet pipe is connected to a side wall of the treatment tank; an ash discharge pipe is connected to the bottom of the treatment tank; an induced draft fan is mounted on the ash discharge pipe;
a cleaning rod is vertically and fixedly connected between the two second fixing rings; brush bristles are uniformly disposed on one side of the cleaning rod adjacent to the ceramic fiber tubes; the brush bristles are capable of contacting with the surface of the ceramic fiber tubes;
an arc length of the arc-shaped movable plate is the same as that of the arc-shaped surrounding plate, and both the arc length of the arc-shaped movable plate and the arc length of the arc-shaped surrounding plate are greater than half of a perimeter of the circumference thereon.

2. The integrated synergistic purification process for sulfur, dust, and nitrogen oxides, using ceramic fiber tube according to claim 1, wherein the air suction assembly comprises a plurality of air suction pipes; the plurality of air suction pipes are respectively distributed in one-to-one correspondence at the tops of the plurality of rows of ceramic fiber tubes; an air compressor is connected to the top of the air suction pipe located in the middle; the air compressor is connected to the exhaust pipe at the top of the treatment tank; the air suction pipe located in the middle position is individually connected to each of the other air suction pipes with a connecting pipe therebetween; a control valve is mounted on the connecting pipe; a plurality of insertion pipes are vertically connected to the bottom of the air suction pipe; the plurality of insertion pipes are respectively inserted in one-to-one correspondence at the top openings of the plurality of ceramic fiber tubes directly below the air suction pipe.

3. The integrated synergistic purification process for sulfur, dust, and nitrogen oxides, using ceramic fiber tube according to claim 1, wherein the driving assembly comprises a driving shaft; the driving shaft is horizontally disposed at the bottom of the fixing plate, and an end of the drive shaft is drivingly connected with a driving motor; fixing blocks are rotatably sleeved on positions of the drive shaft adjacent to opposite ends, and the fixing blocks are fixedly connected to the bottom of the fixing plate; a plurality of first bevel gears are sleeved on the drive shaft, and the plurality of first bevel gears are respectively opposite to the plurality of rotating shafts on the fixing plate in a one-to-one correspondence; a second bevel gear is fixedly sleeved on the bottom end of the rotating shaft, and the second bevel gear engages with the adjacent first bevel gear.

4. The integrated synergistic purification process for sulfur, dust, and nitrogen oxides, using ceramic fiber tube according to claim 1, wherein an annular mounting groove is defined on an inner side of a top edge of the insertion hole; a supporting ring is slidably mounted in the mounting groove; a supporting spring is fixedly connected between a bottom of the supporting ring and an inner wall of a bottom of the mounting groove.

5. The integrated synergistic purification process for sulfur, dust, and nitrogen oxides, using ceramic fiber tube according to claim 1, wherein a diameter of the treatment tank adjacent to the bottom end decreases from the top to the bottom, gradually, and the inner wall of the bottom end of the treatment tank is smooth.

6. The integrated synergistic purification process for sulfur, dust, and nitrogen oxides, using ceramic fiber tube according to claim 4, wherein the top edge of the ceramic fiber tube protrudes outwardly, and a width of a protruding part matches a width of the supporting ring; the bottom end of the ceramic fiber tube is higher than the bottom of the arc-shaped movable plate.

7. The integrated synergistic purification process for sulfur, dust, and nitrogen oxides, using ceramic fiber tube according to claim 6, wherein a gap is formed between the arc-shaped movable plate and the ceramic fiber tube; a gap is formed between two adjacent arc-shaped surrounding plates.
